(19) United States
(12) Patent Application Publication
(10) Pub. No.: US 2024/0126154 A1
(43) Pub. Date: Apr. 18, 2024

(54) SHOE DEVICE AND ACCESSORY PROVIDED WITH THE SHOE DEVICE

(71) Applicant: CANON KABUSHIKI KAISHA, Tokyo (JP)

(72) Inventor: YOSHINOBU OKANO, Saitama (JP)

(21) Appl. No.: 18/481,878

(22) Filed: Oct. 5, 2023

(30) Foreign Application Priority Data
Oct. 18, 2022 (JP) 2022-166755

(51) Int. Cl. G03B 17/56; G03B 15/05

(52) U.S. Cl. CPC G03B 17/566; G03B 15/05; G03B 2215/056

(57) ABSTRACT

A shoe device having a holding member and a support member is attachable to and detachable from an accessory shoe device provided in an electronic device in a first direction, and in which a plurality of contacts to be electrically connected to the electronic device is arranged in a second direction orthogonal to the first direction. The holding member holds the plurality of contacts. The support member supports the plurality of contacts in the first direction. Each of the plurality of contacts is formed with a tip end portion that is exposed in a third direction orthogonal to the first and the second directions with respect to the holding member and comes into contact with the electronic device, and is formed with a bending portion that is connected to the tip end portion and is convex in the third direction. The support member supports the bending portion.

### BACKGROUND

### Field

The present disclosure relates to a shoe device that can be attached to and detached from an accessory shoe device provided in an electronic device and an accessory.

### Description of the Related Art

An imaging apparatus (an electronic device) such as a camera is provided with an accessory shoe device on which a shoe device of an accessory such as a lighting device (a flash unit) is detachably mounted. For example, Japanese Patent Application Laid-Open No. 2020-134682 discusses a configuration in which a part of a contact of a shoe device comes into contact with a contact in an accessory shoe device, and thus the contacts are connected to each other.

Some conventional accessory shoe devices provided in an imaging apparatus are provided with an engagement member that engages with and holds a shoe device of an accessory, and each of the conventional accessory shoe device and the shoe device is provided with a contact for enabling communication between the imaging apparatus and the accessory. However, when a part of the contact of the shoe device is exposed to outside of the shoe device and an external impact is applied to the contact, the contact may be plastically deformed. If the contact is plastically deformed, it is difficult to ensure reliability of communication between the contact of the conventional accessory shoe device and the contact of the shoe device, and communication failure may occur.

### SUMMARY

According to an aspect of the present disclosure, a shoe device that is attachable to and detachable from an accessory shoe device provided in an electronic device in a first direction, and in which a plurality of contacts to be electrically connected to the electronic device is arranged in a second direction orthogonal to the first direction, includes a holding member configured to hold the plurality of contacts, and a support member configured to support the plurality of contacts in the first direction, wherein each of the plurality of contacts is formed with a tip end portion that is exposed in a third direction orthogonal to the first and the second directions with respect to the holding member and configured to come into contact with the electronic device, and is formed with a bending portion that is connected to the tip end portion and is convex in the third direction, and wherein the support member supports the bending portion.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an electronic device according to an exemplary embodiment of the present disclosure.

FIG. 2 is a diagram illustrating a configuration of an accessory according to the exemplary embodiment of the present disclosure.

FIGS. 3A to 3C are perspective views illustrating a mounting operation of the electronic device to the accessory according to the exemplary embodiment of the present disclosure.

FIG. 4 is a perspective view illustrating an accessory shoe device according to the exemplary embodiment of the present disclosure.

FIGS. 5A and 5B illustrate contacts of the accessory shoe device and a shoe device according to the exemplary embodiment of the present disclosure.

FIGS. 6A to 6C are diagrams illustrating a structure of an accessory according to a first exemplary embodiment of the present disclosure.

FIGS. 7A to 7C are diagrams illustrating a structure of an accessory according to a second exemplary embodiment of the present disclosure.

### DESCRIPTION OF THE EMBODIMENTS

Exemplary embodiments according to the present disclosure will be described below with reference to the attached drawings. An imaging system is described below that includes a digital camera (imaging apparatus), which is an electronic device provided with an accessory shoe device, and an external flash unit (lighting device), which is an accessory provided with a shoe device that can be attached to and detached from the accessory shoe device of the digital camera. The accessory provided with the shoe device is not limited to the flash unit, and the examples of the accessory further includes various accessories such as an electronic viewfinder unit, a moving image capturing microphone, a conversion adapter, various measuring instruments, and a sub camera. The examples of the electronic device provided with the accessory shoe device further includes various electronic devices other than an imaging apparatus.

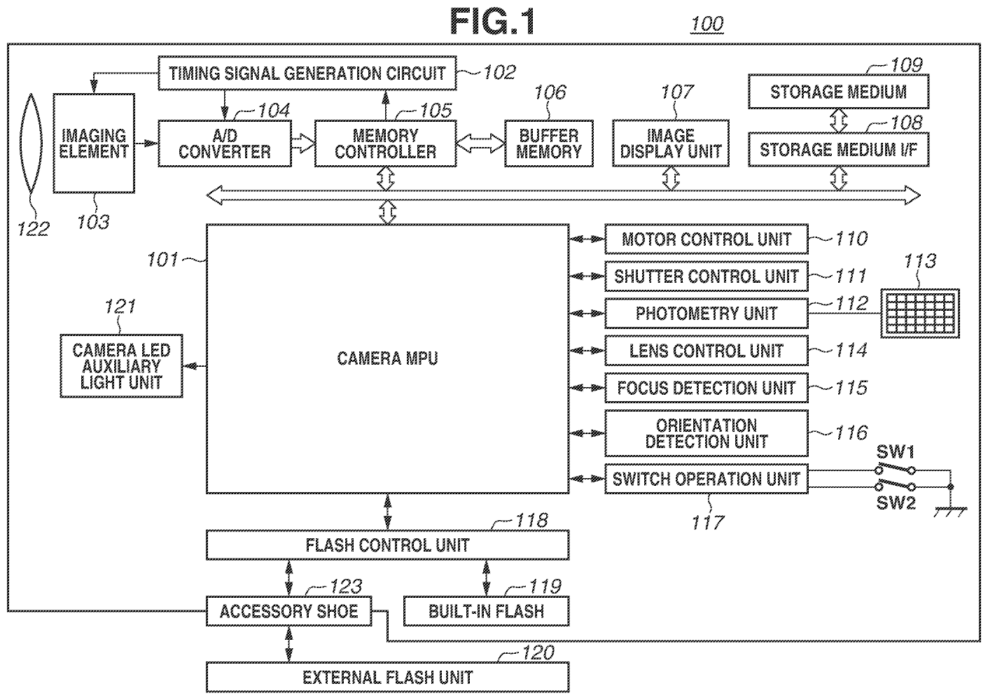

FIG. 1 is a diagram illustrating a configuration of a digital camera (hereinbelow, simply referred to as a camera) 100. The camera 100 includes a camera micro processing unit (MPU) 101, which is a microcomputer, an imaging optical system 122, a timing signal generation circuit 102, an imaging element 103, an analog-to-digital (A/D) converter 104, a memory controller 105, and a buffer memory 106. The camera 100 also includes an image display unit 107, a storage medium interface (UF) 108, a motor control unit 110, a shutter control unit 111, a photometry unit 112, a multi-division photometry sensor 113, a lens control unit 114, a focus detection unit 115, an orientation detection unit 116, and a switch operation unit 117. The camera 100 further includes a flash control unit 118, a built-in flash 119, a camera light emitting diode (LED) auxiliary light unit 121, and an accessory shoe device (hereinbelow, simply referred to as an accessory shoe) 123. An external flash unit 120 as an accessory is mounted on the accessory shoe 123. A storage medium 109 such as a semiconductor memory can be attached to and detached from the camera 100.

The camera MPU 101 controls an imaging sequence of the camera 100 and the entirety of the imaging system. The imaging optical system 122 includes a plurality of lens groups such as a zoom lens and a focus lens, an aperture, and a shutter, and forms light from an object as an optical image (an object image) on the imaging element 103. The imaging element 103 is an image sensor such as a charge coupled device (CCD) sensor or a complementary metal oxide semiconductor (CMOS) sensor that captures (photoelectrically converts) an optical image. The timing signal generation circuit 102 generates a timing signal necessary to operate the imaging element 103.

The A/D converter 104 converts an analog signal read from the imaging element 103 into a digital signal (image data). The memory controller 105 controls reading and writing operations of a memory (not illustrated) and a refresh operation of the buffer memory 106. The buffer memory 106 temporarily stores the image data output from the A/D converter 104 and display image data for displaying an image on the image display unit 107. The image display unit 107 includes a display device such as a liquid crystal panel or an organic electroluminescence (EL) panel, and displays image data accumulated in the buffer memory 106.

The storage medium OF 108 is an interface that enables communication between the mounted storage medium 109 and the camera MPU 101. Other storage media such as a hard disk and an optical disk may be built into the camera 100.

The motor control unit 110 controls a motor (not illustrated) according to a signal from the camera MPU 101 to move a minor (not illustrated) up and down and to charge the shutter. The shutter control unit 111 controls exposure of the imaging element 103 by running leading and trailing curtains of the shutter according to a signal from the camera MPU 101. The multi-division photometry sensor 113 measures luminance of each of a plurality of divided areas within an imaging screen. The photometry unit 112 outputs a luminance signal indicating the luminance of each area to the camera MPU 101. The camera 100 may be configured without a minor or a shutter.

The camera MPU 101 calculates an aperture value (AV), a shutter speed (TV), an International Organization for Standardization (ISO) sensitivity value (sensitivity of the imaging element 103), and the like to adjust exposure based on the luminance signal acquired from the photometry unit 112. The photometry unit 112 outputs the luminance signal to the camera MPU 101 at the time of preliminary light emission (pre-flush) by the built-in flash 119 or the external flash unit 120 toward the object and calculates a light emission amount (a main light emission amount) of the external flash unit 120 at the time of actual imaging. The camera 100 may not include the multi-division photometry sensor 113 and may be configured to substitute a function of the multi-division photometry sensor 113 with the imaging element 103.

The lens control unit 114 communicates with the camera MPU 101 via a mount contact (not illustrated) and controls focus and an aperture value of the imaging optical system 122 by controlling a lens drive motor (not illustrated) and an aperture drive motor (not illustrated). The focus detection unit 115 detects a defocus amount of the imaging optical system 122 using a focus detection method such as a phase difference detection method. The camera MPU 101 calculates a drive amount of the focus lens based on the detected defocus amount and performs auto-focus (AF) by controlling the lens drive motor via the lens control unit 114.

The orientation detection unit 116 detects a tilt of the camera 100 in a rotation direction about an optical axis of the imaging optical system 122. The switch operation unit 117 includes a first switch (SW1) that turns ON by a first stroke operation (half-press) of a release button (not illustrated) and a second switch (SW2) that turns ON by a second stroke operation (full press) of the release button, and outputs each ON signal to the camera MPU 101. The camera MPU 101 starts an imaging preparation operation such as AF and photometry in response to the ON signal from the SW1, and starts an imaging (exposure) operation in response to the ON signal from the SW2. The switch operation unit 117 also outputs to the camera MPU 101 a signal corresponding to an operation performed on an operation member (not illustrated) other than the SW1 and the SW2.

The flash control unit 118 controls light emission (preliminary light emission, main light emission, auxiliary light emission, and the like) of the built-in flash 119 and the external flash unit 120 mounted on the accessory shoe 123 according to an instruction from the camera MPU 101. If the flash control unit 118 detects that the external flash unit 120 is mounted on the accessory shoe 123, the flash control unit 118 starts supplying power to the external flash unit 120 via the accessory shoe 123. A detailed configuration of the accessory shoe 123 is described below.

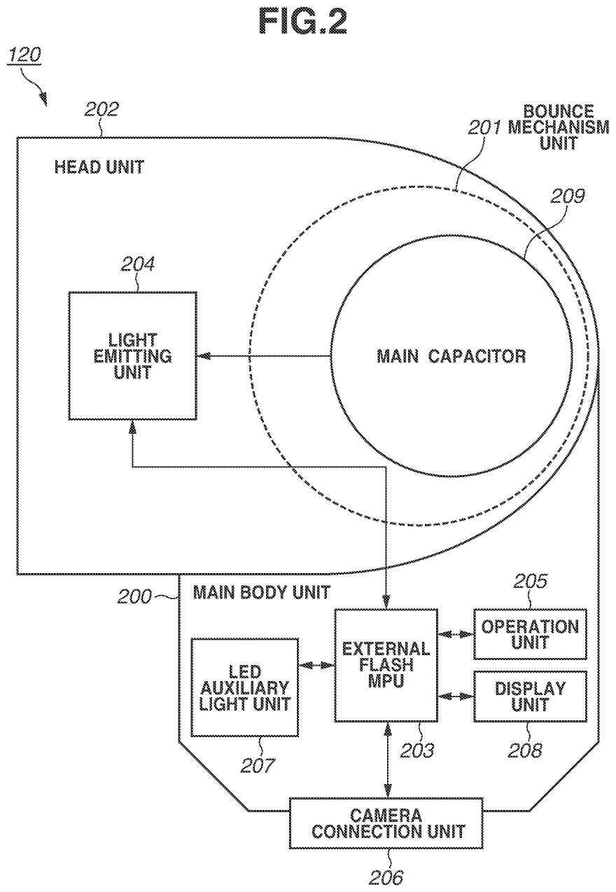

The camera LED auxiliary light unit 121 irradiates the object with near-infrared light (LED auxiliary light) having a predetermined pattern used as auxiliary light for focus detection by the focus detection unit 115. The camera MPU 101 controls emission of auxiliary light by the built-in flash 119 or the external flash unit 120 for focus detection based on the luminance signal from the photometry unit 112. Specifically, the camera MPU 101 instructs the built-in flash 119 or the external flash unit 120 to emit the auxiliary light via the flash control unit 118. The camera MPU 101 can also instruct the camera LED auxiliary light unit 121 or an LED auxiliary light unit 207 of the external flash unit 120 illustrated in FIG. 2 to emit LED auxiliary light via the flash control unit 118.

FIG. 2 is a diagram illustrating a configuration of the external flash unit 120 as an example of the accessory according to the present exemplary embodiment. The external flash unit 120 includes a main body unit 200, a bounce mechanism unit 201, and a head unit 202. The main body unit 200 includes an external flash MPU 203, a main capacitor 209, an operation unit 205 including a power supply switch, a display unit 208, the LED auxiliary light unit 207, and a camera connection unit 206.

The external flash MPU 203 is mounted on a main substrate (not illustrated) and controls all operations including a light emission control sequence of the external flash unit 120. The camera connection unit 206 is a shoe device that mechanically and electrically connects the external flash unit 120 to the accessory shoe 123 of the camera 100. The camera MPU 101 and the external flash MPU 203 communicate with each other via the flash control unit 118, the accessory shoe 123, and the camera connection unit 206. A detailed configuration of the camera connection unit 206 is described below.

The LED auxiliary light unit 207 irradiates the object with LED auxiliary light such as near-infrared light having a predetermined pattern as auxiliary light at the time of focus detection using the focus detection unit 115 by the camera MPU 101 in the similar manner to the camera LED auxiliary light unit 121. The bounce mechanism unit 201 is a mechanism for rotating the head unit 202 in a horizontal direction and a vertical direction with respect to the main body unit 200 to change an emission direction of illumination light (flash light) from the head unit 202. It is possible to indirectly illuminate an object and perform imaging (bounce imaging) by using the bounce mechanism unit 201. The head unit 202 includes a light emitting unit 204 that emits a flash light. The light emitting unit 204 includes a light source such as a light emitting discharge tube (such as a xenon tube) or an LED, a reflection umbrella, a Fresnel lens, and a light emitting circuit. The light emitting circuit causes the light source to emit a flash light according to a signal from the external flash MPU 203.

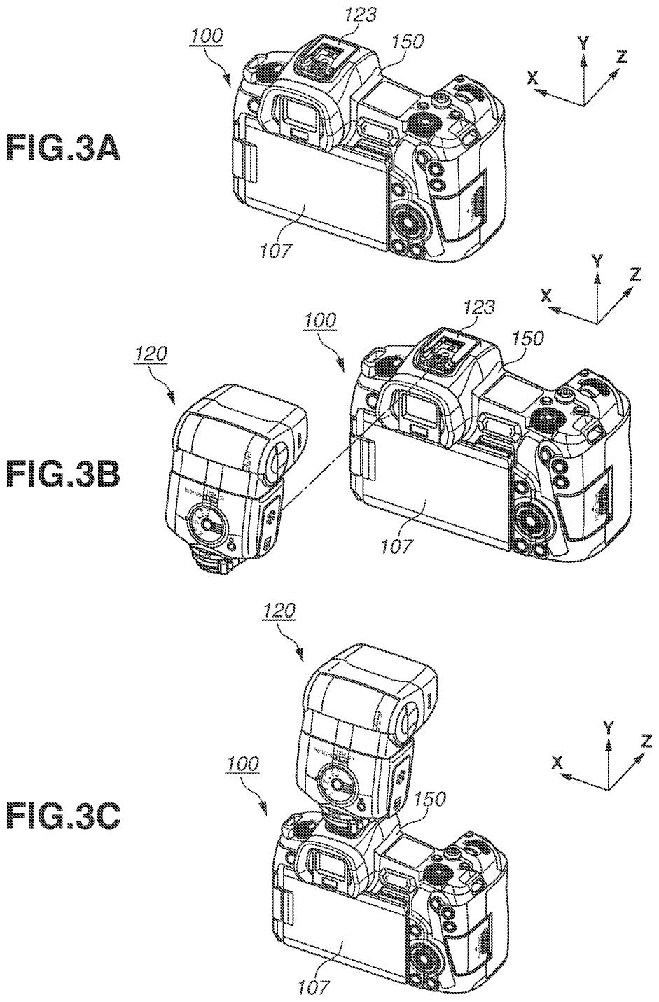

FIGS. 3A to 3C are diagrams illustrating a mounting operation of the electronic device to the accessory. FIG. 3A illustrates the camera 100 viewed obliquely from a rear side. FIG. 3B illustrates a method for mounting the external flash unit 120 on the accessory shoe 123 of the camera 100. FIG. 3C illustrates a state in which the external flash unit 120 is mounted on the camera 100 viewed obliquely from the rear side.

The imaging optical system 122 illustrated in FIG. 1 is provided on a front side (an object side) of the camera 100, and the image display unit 107 is provided on the rear side of the camera 100. A top cover 150 is provided as an exterior member on an upper surface portion of the camera 100, and the accessory shoe 123 is arranged on the top cover 150. Meanwhile, the camera connection unit 206 is provided on the bottom of the external flash unit 120.

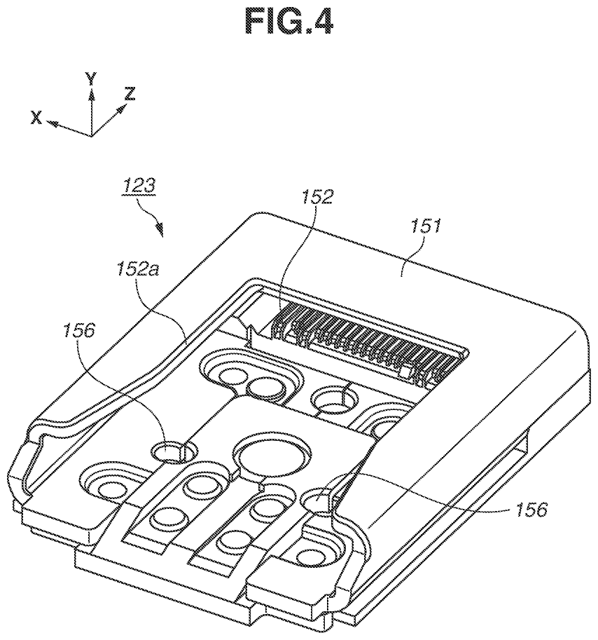

As illustrated in FIG. 3B, the external flash unit 120 is slid parallel to the camera 100 toward the front side in a Z direction (a mounting side in a first direction) to engage the camera connection unit 206 with the accessory shoe 123. Accordingly, the external flash unit 120 can be mounted on the camera 100. The front side in the Z direction is a direction from the rear side to the front side of the camera 100, that is, a direction from an image display unit 107 side to an imaging optical system 122 side. An X direction (a second direction), a Y direction (a third direction), and the Z direction (the front-rear direction) indicated in FIG. 4 and subsequent drawings are common. The X direction is a direction orthogonal to the Z direction in a horizontal plane if the Z direction is parallel to the horizontal direction, and is also a width direction of the camera 100. The Y direction is a direction orthogonal to the Z direction and the X direction, and is also a height direction of the camera 100.

Next, the accessory shoe 123 of the camera 100 is described with reference to FIG. 4. FIG. 4 is a top perspective view of the accessory shoe 123.

The accessory shoe 123 includes an engagement member 151 and a signal terminal connector 152.

The engagement member 151 is a member for engaging and holding the external flash unit 120. The external flash unit 120 is slid parallel to the camera 100 toward the front side in the Z direction (the mounting side in the first direction) to engage the camera connection unit 206 with the engagement member 151 of the accessory shoe 123. If the external flash unit 120 is slid parallel to the camera 100 in a state where they are not sufficiently aligned, the external flash unit 120 may collide with the engagement member 151. In order to reduce an external impact applied to the external flash unit 120 in the event of a collision, C chamfering 152a is provided on an exposed edge portion of the engagement member 151. Accordingly, the external impact applied to the external flash unit 120 can be reduced as compared to a case where the external flash unit 120 hits an edge, and the external flash unit 120 is less likely to be damaged. According to the present exemplary embodiment, the C chamfering is used as an example, but a similar effect can be acquired with R chamfering.

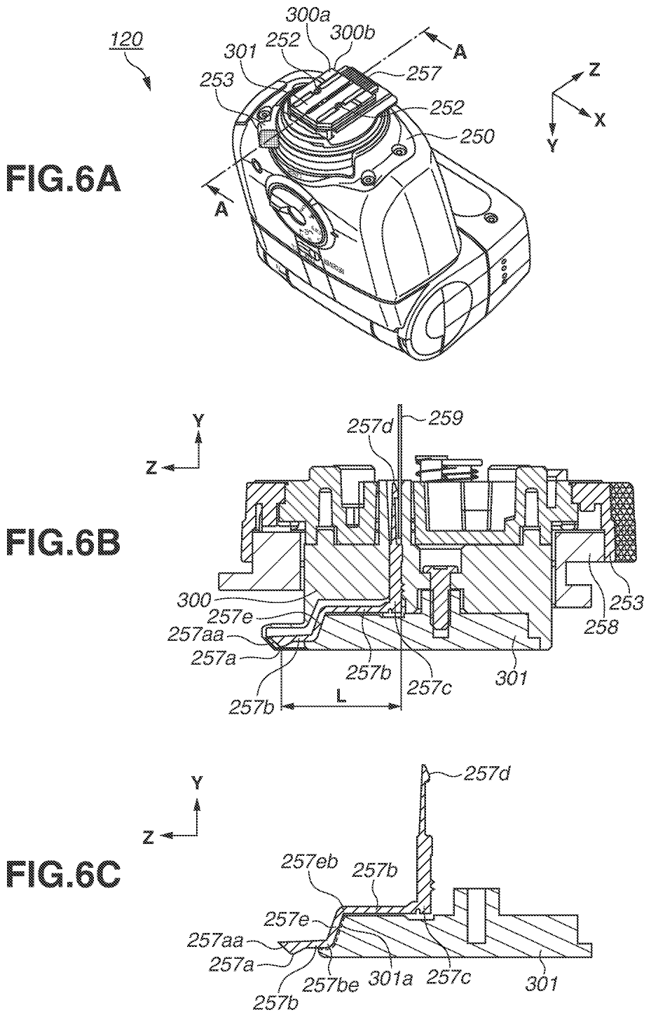

The signal terminal connector 152 includes 21 contacts TC01 to TC21 arranged in parallel in the X direction at equal pitches on a connector base member formed of a synthetic resin material or the like. In FIG. 4, the signal terminal connector 152 is arranged in the mounting direction of the external flash unit 120, that is, in the front side in the Z direction. Engagement holes 156 with which lock pins 252 (see FIG. 6A described below) of the external flash unit 120 engage are provided on a rear side of the signal terminal connector 152 in the Z direction.

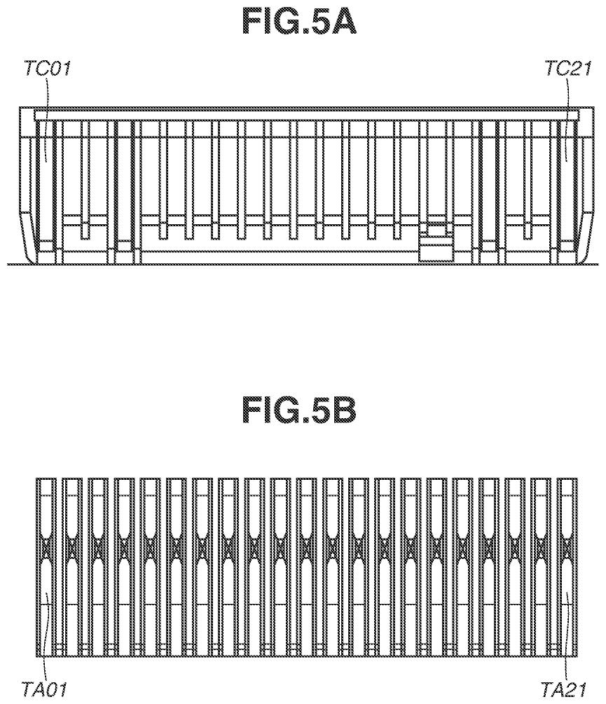

FIGS. 5A and 5B are diagrams illustrating contacts of the accessory shoe device and the shoe device. FIG. 5A illustrates an arrangement example of the 21 contacts TC01 to TC21 in the accessory shoe 123 viewed in a −Y direction. FIG. 5B illustrates an arrangement example of 21 contacts TA01 to TA21 in the camera connection unit 206 viewed in the −Y direction.

The plurality of contacts TC01 to TC21 of the accessory shoe 123 comes in contact with the plurality of contacts TA01 to TA21 of the camera connection unit 206 in a one-to-one basis, and thus the camera 100 and the external flash unit 120 are electrically connected. According to the present exemplary embodiment, the contact TC01 is arranged at a right end viewed from the object side, and the 21 contacts up to the contact TC21 are arranged in a row. Similarly, the contact TA01 is arranged at the right end viewed from the object side, and the 21 contacts up to the contact TA21 are arranged in a row.

The camera connection unit 206 is mounted on the accessory shoe 123 by sliding in a longitudinal direction (the Z direction) of each contact in FIG. 5B. In a case where a plurality of contacts is arranged in the same row as in FIGS. 5A and 5B, each of the contacts TA01 to TA21 comes into contact with a corresponding one of the corresponding contacts TC01 to TC21 almost at the same time. In FIGS. 5A and 5B, the accessory shoe 123 and the camera connection unit 206 have the same number of contacts, but do not necessarily need to have the same number of contacts. For example, the accessory shoe 123 may have a first number of contacts for electrically connecting with a plurality of types of accessories, and the camera connection unit 206 may have a second number of contacts that is less than the first number. However, even in such a configuration, it is desirable to arrange a plurality of contacts of the camera connection unit 206 in parallel so that the contacts of the camera connection unit 206 are in one-to-one contact with the contacts of the accessory shoe 123.

Next, a structure of an accessory according to a first exemplary embodiment of the present disclosure is described with reference to FIGS. 6A to 6C. FIG. 6A illustrates the external flash unit 120 viewed from a camera connection unit 206 side (a lower side in the Y direction). FIG. 6B illustrates an internal structure of the camera connection unit 206 in a cross section along an A-A line in FIG. 6A. FIG. 6C illustrates only a connection terminal 257 and a shoe cover 301 in the internal structure illustrated in FIG. 6B.

The camera connection unit 206 is provided on the lower side in the Y direction (an upper side in FIG. 6A) of a base portion 250 of the external flash unit 120 as illustrated in FIG. 6B in a state of being mounted on the accessory shoe 123 of the camera 100. The camera connection unit 206 includes a shoe mounting leg 300a, the lock pins 252, a lock lever 253, a connection plug 300b, a Y-direction holding member 258, a holding member 300, and the shoe cover 301.

The shoe mounting leg 300a is an engagement member for engaging the external flash unit 120 with the accessory shoe 123 of the camera 100. In other words, the shoe mounting leg 300a is an engagement member of the external flash unit 120 that can be attached to and detached from the accessory shoe 123.

The lock pins 252 are fixing members for preventing the external flash unit 120 from falling in a state in which the shoe mounting leg 300a is mounted on the accessory shoe 123, and the lock pins 252 are held by the shoe mounting leg 300a to be movable in the Y direction. Specifically, the lock pins 252 are held by the Y-direction holding member 258 to be slidable in the Y direction. The lock lever 253 and the Y-direction holding member 258 are held by the holding member 300.

If the external flash unit 120 is mounted on the accessory shoe 123 and the lock lever 253 is rotated, the Y-direction holding member 258 is moved downward in the Y direction in FIG. 6B by a cam portion (not illustrated). At that time, the lock pins 252 are also moved downward in the Y direction in FIG. 6B together with the Y-direction holding member 258. Accordingly, the lock pins 252 protrude from the shoe mounting leg 300a and engage with the engagement holes 156 of the accessory shoe 123.

The connection plug 300b is provided on the front side in the Z direction and is formed of a non-conductive material (dielectric material) such as a resin material. The connection plug 300b is integrally formed with the holding member 300. The connection plug 300b includes the connection terminal 257 (the plurality of contacts TA01 to TA21) that abuts on and is electrically connected to the contacts TC01 to TC21 of the accessory shoe 123.

The contacts TA01 to TA21 of the connection terminal 257 are provided in one-to-one correspondence with the contacts TC01 to TC21 and are inserted into and supported by grooves, which are formed in the holding member 300 to extend in the Z direction and to align in the X direction. Each of the contacts TA01 to TA21 has a tip inclined portion 257aa and a tip end portion 257a that come into contact with a corresponding one of the contacts TC01 to TC21. Each of the contacts TA01 to TA21 also has a shape extending rearward in the Z direction from the tip end portion 257a. Specifically, each of the contacts TA01 to TA21 includes an extension portion 257b that displaces the tip end portion 257a upward in the Y direction in FIG. 6B by elastic deformation when the tip inclined portions 257aa and the tip end portions 257a abut on the contacts TC01 to TC21. A straight extension portion 257c extending upward in the Y direction is formed at a rear end of the extension portion 257b in the Z direction. At an upper end of the straight extension portion 257c, a flexible substrate connection portion 257d is provided, and the flexible substrate connection portion 257d is connected to a flexible substrate 259 that is connected to the main substrate (not illustrated) of the external flash unit 120 and inserted into the holding member 300 from above in the Y direction. A step portion 257e having a step in the Y direction is formed in the middle of the extension portion 257b in the Z direction. Each of the contacts TA01 to TA21 includes a bending portion 257be that is convex downward in the Y direction (−Y direction) and a bending portion 257eb that is convex upward in the Y direction (+Y direction), and they connect the extension portions 257b and the step portion 257e. The configuration in which the bending portion 257be is convex downward in the Y direction includes a configuration in which the bending portion 257be is located in a lower area in the Y direction of two areas in a YZ plane divided by a straight line connecting ends of two sides sandwiching the bending portion 257be that are not on the bending portion 257be side. Similarly, the configuration in which the bending portion 257eb is convex upward in the Y direction includes a configuration in which the bending portion 257eb is located in an upper area in the Y direction of two areas in the YZ plane divided by a straight line connecting ends of two sides sandwiching the bending portion 257eb that are not on the bending portion 257eb side.

As described above, the extension portion 257b is elastically deformable in the Y direction. However, if a distance L of the extension portion 257b in the Z direction is short, a sufficient amount of deformation cannot be obtained. As a result, durability is lowered, and if the contacts TC01 to TC21 are repeatedly brought into contact with and separated from the tip end portions 257a, the extension portions 257b may be damaged. Thus, the step portion 257e is provided in each extension portion 257b, so that it is possible to extend the distance of elastic deformation and to suppress damage. According to the present exemplary embodiment, contours of the bending portions 257be and 257eb are curved lines, but do not necessarily need to be curved lines and may be straight lines.

Lubricant is applied to the tip end portions 257a, the extension portions 257b, and the step portions 257e of the connection terminal 257. The lubricant is applied, and thus it is possible to improve connection reliability and durability of contact portions with the plurality of contacts TC01 to TC21 of the accessory shoe 123 provided on the camera 100. Further, the durability can be improved by reducing friction of a contact portion with the holding member 300 at the time of elastic deformation of the connection terminal 257.

Next, the shoe cover 301 is described. The shoe cover 301 is a cover located below the camera connection unit 206 in the Y direction to protect the connection terminal 257. The shoe cover 301 is formed at a tip end portion in the Z direction to cover the connection terminal 257 and thus prevents deformation of the connection terminal 257 due to contact with an external object and adhesion of a foreign substance, a water droplet, and the like to the connection terminal 257. The shoe cover 301 is a support member having a support portion 301a for suppressing deformation of the connection terminal 257 caused by an impact applied to the tip end portions 257a and the tip inclined portions 257aa of the connection terminal 257. The shoe cover 301 is arranged very close to the connection terminal 257 and thus is formed of a non-conductive member so that each of the contacts TA01 to TA21 of the connection terminal 257 is not electrically short-circuited.

The support portion 301a at the tip end of the shoe cover 301 in the Z direction is described in detail with reference to FIG. 6C. The support portion 301a is formed along contours of the extension portions 257b, the bending portions 257be, and the step portions 257e of the connection terminal 257. The support portion 301a formed along the contours serves to support the connection terminal 257 and reduce plastic deformation of the connection terminal 257 in a case where the connection terminal 257 receives an external impact. In a case where a force caused by an external impact or the like is applied to the tip inclined portions 257aa of the connection terminal 257 substantially in the Z direction, each extension portion 257b is elastically deformed in the Y direction as described above so as to suppress the connection terminal 257 from being damaged. However, in a case where an external impact occurs instantaneously, the connection terminal 257 cannot elastically deform in the Y direction and may deform in the −Z direction as a result. Particularly, in a case where a large external impact occurs instantaneously due to a collision with an object formed of a material that is harder than the material of the connection terminal 257 and has a sharp shape, a risk of deformation in the −Z direction increases. In order to reduce the foregoing deformation in the −Z direction, it is desirable to make a gap between the support portion 301a and the extension portions 257b, the bending portions 257be, and the step portions 257e of the connection terminal 257 as small as possible. Specifically, it is desirable to make the gaps between the support portion 301a and the extension portions 257b, the bending portions 257be, and the step portions 257e of the connection terminal 257 smaller than a displacement amount at which the connection terminal 257 causes plastic deformation. According to the present exemplary embodiment, the support portion 301a is formed along the contours of the extension portions 257b, the bending portions 257be, and the step portions 257e of the connection terminal 257. However, in order to efficiently reduce the plastic deformation of the connection terminal 257, it is effective to support the connection terminal 257 with the support portion 301a at a point where the displacement amount of the connection terminal 257 is maximum on an extension line in the direction in which an external impact is applied. In other words, it is desirable to support each bending portion 257be located on the extension line in the Z direction of the corresponding tip inclined portion 25aa with the support portion 301a in a case where an external impact is applied to the tip inclined portion 257aa in the Z direction. Thus, if the support portion 301a is configured to support at least the bending portion 257be located on the extension line in the Z direction of the tip inclined portion 257aa, an effect of reducing the plastic deformation of the connection terminal 257 can be acquired even if the extension portion 257b and the step portion 257e are not supported.

As described above, the plastic deformation of the connection terminal 257 due to an external impact can be reduced by supporting the connection terminal 257 at a point where the displacement amount of the connection terminal 257 is the maximum with the support portion 301a on the extension line in the direction in which the external impact is applied.

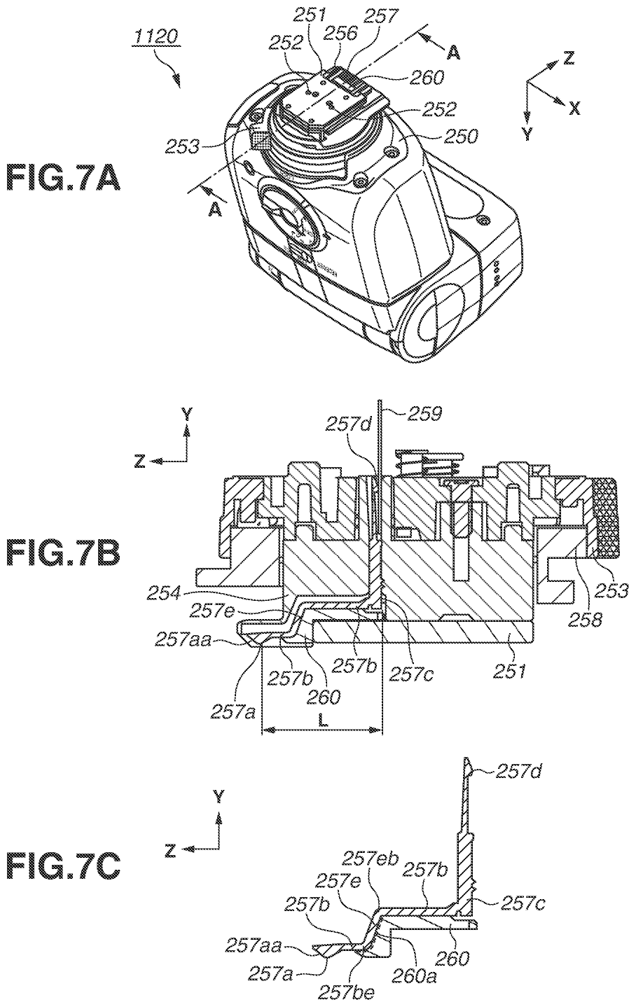

Next, a structure of an accessory according to a second exemplary embodiment of the present disclosure is described with reference to FIGS. 7A to 7C. The accessory according to the second exemplary embodiment differs in the structure supporting the connection terminal 257 from the accessory according to the first exemplary embodiment. In FIGS. 7A to 7C, components similar to those in FIGS. 6A to 6C are denoted by the same reference numerals.

FIG. 7A illustrates an external flash unit 1120 viewed from the camera connection unit 206 side (the lower side in the Y direction). FIG. 7B illustrates an internal structure of the camera connection unit 206 in a cross section along an A-A line in FIG. 7A. FIG. 7C illustrates only the connection terminal 257 and a spacer 260 in the internal structure illustrated in FIG. 7B.

The camera connection unit 206 is provided on the lower side in the Y direction (an upper side in FIG. 7A) of the base portion 250 of the external flash unit 1120 as illustrated in FIG. 7B in a state of being mounted on the accessory shoe 123 of the camera 100. The camera connection unit 206 includes a shoe mounting leg 251, the lock pins 252, the lock lever 253, a connection plug 256, the Y-direction holding member 258, a holding member 254, and the spacer 260.

The shoe mounting leg 251 is an engagement member for engaging the external flash unit 1120 with the accessory shoe 123 of the camera 100. In other words, the shoe mounting leg 251 is an engagement member of the external flash unit 1120 that can be attached to and detached from the accessory shoe 123. The shoe mounting leg 251 is a component that receives large stress caused by an external force such as pressure or an impact applied to the external flash unit 120, and thus is formed by processing a metal plate material (sheet metal) that has high mechanical strength. The shoe mounting leg 251 is fastened to the holding member 254 with screws (not illustrated). According to the present exemplary embodiment, the number of contacts of the connection terminal 257 is less than that according to the first exemplary embodiment. Specifically, the connection terminal 257 according to the present exemplary embodiment includes only contacts corresponding to the contacts TA04 to TA18 according to the first exemplary embodiment, and the contacts TA01 to TA03 and the contacts TA19 to TA21 are not provided. Thus, according to the present exemplary embodiment, the shoe mounting leg 251 and the holding member 254 are fastened with screws (not illustrated) at positions where the contacts TA01 to TA03 and the contacts TA19 to TA21 exist in the first exemplary embodiment.

The lock pins 252 are fixing members for preventing the external flash unit 1120 from falling in a state in which the shoe mounting leg 251 is mounted on the accessory shoe 123, and are held by the shoe mounting leg 251 to be movable in the Y direction. Specifically, the lock pins 252 are held by the Y-direction holding member 258 to be slidable in the Y direction. The lock lever 253 and the Y-direction holding member 258 are held by the holding member 254.

If the external flash unit 1120 is mounted on the accessory shoe 123 and the lock lever 253 is rotated, the Y-direction holding member 258 is moved downward in the Y direction in FIG. 7B by the cam portion (not illustrated). At that time, the lock pins 252 are also moved downward in the Y direction in FIG. 7B together with the Y-direction holding member 258. Accordingly, the lock pins 252 protrude from the shoe mounting leg 251 and engage with the engagement holes 156 of the accessory shoe 123.

The connection plug 256 is provided on the front side in the Z direction and is formed of a non-conductive material (dielectric material) such as a resin material. The connection plug 256 is integrally formed with the holding member 254. The connection plug 256 includes the connection terminal 257 (a plurality of contacts TA04 to TA18) that abuts on and is electrically connected to the contacts TC04 to TC18 of the accessory shoe 123.

The contacts TA04 to TA18 of the connection terminal 257 are provided in one-to-one correspondence with the contacts TC04 to TC18 and are inserted into and supported by grooves, which are formed in the holding member 254 to extend in the Z direction and to align in the X direction.

The shape of the contacts TA04 to TA18 and application of lubricant are the same as those of the contacts TA01 to TA21 according to the first exemplary embodiment, so that a detailed description is omitted.

Next, the spacer 260 is described. The spacer 260 is a cover that is located below the camera connection unit 206 in the Y direction and is arranged between the holding member 254 and the shoe mounting leg 251 to protect the connection terminal 257. The spacer 260 is formed to cover a gap between the shoe mounting leg 251 and the connection terminal 257 and thus prevents deformation of the connection terminal 257 due to contact with an external object and intrusion of a foreign substance, a water droplet, and the like into the interior. The spacer 260 is a support member having a support portion 260a for suppressing deformation of the connection terminal 257 caused by a force applied to the tip end portions 257a and the tip inclined portions 257aa of the connection terminal 257 due to an external impact. The spacer 260 is arranged very close to the connection terminal 257 and thus is formed of a non-conductive member so that each of the contacts TA04 to TA18 of the connection terminal 257 is not electrically short-circuited.

The support portion 260a at the tip end of the spacer 260 in the Z direction is described in detail with reference to FIG. 7C. The support portion 260a is formed along the contours of the extension portions 257b, the bending portions 257be, and the step portions 257e of the connection terminal 257. The support portion 260a formed along the contours serves to support the connection terminal 257 and reduce plastic deformation of the connection terminal 257 in a case where the connection terminal 257 receives an external impact. In a case where a force caused by an external impact or the like is applied to the tip inclined portions 257aa of the connection terminal 257 substantially in the Z direction, the extension portions 257b are elastically deformed in the Y direction as described above so as to suppress the connection terminal 257 from being damaged. However, in a case where an external impact occurs instantaneously, the connection terminal 257 cannot elastically deform in the Y direction and may deform in the −Z direction. Particularly, in a case where a large external impact occurs instantaneously due to a collision of an object formed of a material that is harder than the material of the connection terminal 257 and has a sharp shape, a risk of deformation in the −Z direction increases. In order to reduce the foregoing deformation in the −Z direction, it is desirable to make a gap between the support portion 260a and the extension portions 257b, the bending portions 257be, and the step portions 257e of the connection terminal 257 as small as possible. Specifically, it is desirable to make the gap between the support portion 260a and the extension portions 257b, the bending portions 257be, and the step portions 257e of the connection terminal 257 smaller than a displacement amount at which the connection terminal 257 causes plastic deformation. According to the present exemplary embodiment, the support portion 260a is formed along the contours of the extension portions 257b, the bending portions 257be, and the step portions 257e of the connection terminal 257. However, in order to efficiently reduce the plastic deformation of the connection terminal 257, it is effective to support the connection terminal 257 with the support portion 260a at a point where the displacement amount of the connection terminal 257 is maximum on the extension line in the direction in which an external impact is applied. In other words, it is desirable to support each bending portion 257be located on the extension line in the Z direction of the corresponding tip inclined portion 257aa with the support portion 260a in a case where an external impact is applied to the tip inclined portions 257aa in the Z direction. Thus, if the support portion 260a is configured to support at least the bending portion 257be located on the extension line in the Z direction of the tip inclined portion 257aa, an effect of reducing the plastic deformation of the connection terminal 257 can be acquired even if the extension portion 257b and the step portion 257e are not supported.

As described above, the plastic deformation of the connection terminal 257 due to an external impact can be reduced by supporting the connection terminal 257 at a point where the displacement amount of the connection terminal 257 is the maximum with the support portion 260a on the extension line in the direction in which the external impact is applied.

According to the above-described two exemplary embodiments, the configuration in which the connection terminal 257 is provided with the step portions 257e is described. However, the number and presence or absence of the step portions are not particularly limited. For example, a configuration in which two or more step portions are provided or a configuration in which the straight extension portion 257c and the bending portion 257be are connected by a linear inclined portion may be adopted. Further, a configuration may be adopted in which the straight extension portion 257c extends to a position aligned with the tip inclined portion 257aa in the Z direction, and a linear extension portion 257b parallel to the Z direction is provided from the straight extension portion 257c. In this configuration, a portion where the straight extension portion 257c and the extension portion 257b intersect corresponds to the bending portion 257be, the portion is supported.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-166755, filed Oct. 18, 2022, which is hereby incorporated by reference herein in its entirety.

What is claimed is:

1. A shoe device that is attachable to and detachable from an accessory shoe device provided in an electronic device in a first direction, and in which a plurality of contacts to be electrically connected to the electronic device is arranged in a second direction orthogonal to the first direction, the shoe device comprising:
a holding member configured to hold the plurality of contacts; and
a support member configured to support the plurality of contacts in the first direction,
wherein each of the plurality of contacts is formed with a tip end portion that is exposed in a third direction orthogonal to the first and the second directions with respect to the holding member and configured to come into contact with the electronic device, and is formed with a bending portion that is connected to the tip end portion and is convex in the third direction, and
wherein the support member supports the bending portion.

2. The shoe device according to claim 1, wherein each of the plurality of contacts is formed with an extension portion that connects the tip end portion and the bending portion and extends in the first direction.

3. The shoe device according to claim 1, wherein the support member is formed along a contour of the bending portion.

4. The shoe device according to claim 3, wherein the contour of the bending portion is a curved line.

5. The shoe device according to claim 3, wherein the contour of the bending portion is a straight line.

6. The shoe device according to claim 1, wherein the support member is formed of a non-conductive member.

7. The shoe device according to claim 1, wherein a gap between the bending portion and the support member is smaller than a displacement amount that causes plastic deformation of each of the plurality of contacts.

8. An accessory comprising the shoe device according to claim 1.

9. The accessory according to claim 8, wherein the accessory is a lighting device.
